(19) United States
(12) Patent Application Publication
(10) Pub. No.: US 2008/0117194 A1
(43) Pub. Date: May 22, 2008

(54) Apparatus and method of driving for plasma display panel

(76) Inventor: Jung-soo An, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/984,592

(22) Filed: Nov. 20, 2007

(30) Foreign Application Priority Data
Nov. 21, 2006 (KR) 10-2006-0115153

(51) Int. Cl. G06F 3/038; G09G 3/28

(52) U.S. Cl. 345/204; 345/68

(57) ABSTRACT

A method for driving a plasma display panel including a plurality of display electrodes and a plurality of address electrodes crossing the display electrodes, and an energy recovery circuit including a power charging/discharging capacitor, an inductor, and a plurality of switches, the method including continuously applying a first sustain discharge signal having a predetermined ascent period for n times to the display electrodes, and continuously applying a second sustain discharge signal having a longer ascent period than the predetermined ascent period for m times to the display electrodes.

### BACKGROUND OF THE INVENTION

1. Field of the Invention

Embodiments relate to a method for driving a plasma display panel (“PDP”), and more particularly, to an apparatus and a method for driving a PDP in which a configuration of a sustain discharge signal is modified to improve a low discharge generated in a high temperature in driving the PDP.

2. Description of the Related Art

At first, a conventional PDP panel and a method for driving the same will be described in brief.

FIG. 1 illustrates a PDP 1 that is driven in an AC-type 3-electrode surface emitting manner.

Referring to FIG. 1, the PDP 1 may include address electrode lines (AR1, AG1, . . . , AGm, ABm); dielectric layers 11, 15; scan electrodes (Y1, . . . Yn) arranged in perpendicular with the address electrodes; sustain (common) electrodes (X1, . . . Xn) arranged parallel to the scan electrodes and forming a pair with the scan electrodes; and a passivation layer, e.g., a magnesium oxide (MgO) layer, between first and second substrates 10, 13. The electrode pair XY formed by the scan electrodes and the sustain electrodes may be generally referred to as “display electrodes.” The PDP 1 may also include barrier ribs 17 for defining discharge cells 14 to be filled with a discharge gas between the first and second substrates 10, 13. Photoluminescent materials 16, e.g., phosphors, may be provided on the barrier ribs 17 and may emit R, G and B visible light.

In the driving the PDP 1, reset, address, and sustain steps are typically sequentially carried out in a unit subfield. The reset step may place all discharge cells 14 in a uniform charge state. The address step may generate a predetermined wall voltage in selected discharge cells 14. During the sustain step, a predetermined AC voltage may be applied to all XY electrode line pairs. Thus, a sustain discharge may occur in the discharge cells 14 in which the wall voltage was formed in the address step. In the sustain step, plasma is formed in selected discharge cells 14, causing the sustain discharge emitting ultraviolet (UV) light, which, in turn, excites the photoluminescent material 16 to generate visible light.

FIG. 2 illustrates driving signals of the PDP 1 shown in FIG. 1, including driving signals applied to the address electrode (A), the common electrode (X), and the scan electrode (Y) in one subfield (SF) in an address display separation (ADS) driving system of an AC PDP.

Referring to FIG. 2, one subfield (SF) may include a reset period, an address period and a sustain discharge period.

Wall charge states of the all of the discharge cells 14 may be reset by applying a reset signal to scan lines of all groups during a reset period to carry out an addressing discharge over the entire display. The reset period may be carried out before the address period. After the reset period, all the discharge cells 14 may be in a uniform wall charge state, since a reset signal has been applied to the entire PDP 1. During the reset period, a voltage of the Y electrode may be gradually increased from Vs to Vset while the A electrode may be maintained at a reference voltage. During the ascent period of the reset signal, a faint discharge may be generated, e.g., between the Y electrode and the X electrode, and between the Y electrode and the A electrode, as a voltage of the Y electrode is increased. Therefore a (−) wall charge may be formed on the Y electrode, and a (+) wall charge may be formed on the X and A electrodes. If the voltage of the electrode is gradually changed, then a wall charge is formed so that the sum of an external voltage and the wall voltage of the cells may be maintained in a state of a firing voltage while the weak discharge is generated in the discharge cells.

Then, a voltage of the Y electrode may decrease from a Vs voltage to a Vnf voltage while the A electrode is maintained at the reference voltage during the descent period of the reset signal. Then, the (−) wall charge formed on the Y electrode and the (+) wall charge formed on the X electrode and the A electrode may be erased during a period when the weak discharge is generated between, e.g., the Y electrode and the X electrode, and between the Y electrode and the A electrode, as the voltage of the Y electrode is decreased. After the reset period, all discharge cells may have substantially uniform wall charge conditions.

An address period may be carried out after the reset period. During the address period, a display cell may be selected by applying a bias voltage to the common electrodes (X1˜Xn) and simultaneously turning on the scan electrodes (Y1˜Yn) and the address electrodes (A1˜Am) in the discharge cells which are to display an image. For the cells turned on during the address period, a scan pulse having a voltage of VscL may be supplied to a corresponding scan electrode.

After the address period, during the sustain discharge period, the sustain pulse (Vs) may be alternately applied to the common electrode (X) and the scan electrode (Y). A low-level voltage (0V) may be applied to the address electrodes (A) during the sustain discharge period. A luminance in the PDP 1 may be adjusted in accordance with a number of sustain discharge pulses. The luminance increases as the number of sustain discharge pulses increases in one subfield.

A firing voltage and discharge characteristics of the PDP 1, as described above, may vary with temperature. Paschen's law illustrates a basic principle of generating a plasma, i.e., that a firing voltage (V) is proportional to the product of a pressure (P) of gas and a distance (D) between electrodes, as shown in Equation 1.

V∝P·D (1)

Since, the pressure inside the PDP 1 increases as temperature inside the PDP increases, for a given distance between electrodes, the firing voltage will increase. Thus, address discharge may not be easily realized, resulting in a low discharge phenomenon in which a discharge is not generated or is weakly generated during a sustain period.

### SUMMARY OF THE INVENTION

Accordingly, embodiments are therefore directed to an apparatus and method for driving a plasma display panel, which substantially overcome one or more of the problems due to the limitations and disadvantages of the related art.

It is therefore a feature of an embodiment to provide to an apparatus and method for driving a plasma display panel in which first and second sustain discharge signals are applied by group, an ascent period of the first and second sustain discharge signals being different.

At least one of the above and other features and advantages of embodiments may be realized by providing a method for driving a plasma display panel including a method for driving a plasma display panel including a plurality of display electrodes and a plurality of address electrodes crossing the display electrodes, an energy recovery circuit including a power charging/discharging capacitor, an inductor, and a plurality of switches, the method including continuously applying a first sustain discharge signal having a predetermined ascent period for n times to the display electrodes, and continuously applying a second sustain discharge signal having a longer ascent period than the predetermined ascent period for m times to the display electrodes.

The predetermined ascent period of the first sustain discharge signal may equal a time required for the voltage to increase to half of a maximum amplitude (Vs) of the first sustain discharge signal.

A ratio of the m second sustain discharge signals to the n first sustain discharge signals is about ⅓ or more.

The method may determine ascent periods by controlling a turn-on timing of a second switch, configured to control connection of the display electrode with a voltage source for supplying a sustain voltage, after a first switch, configured to control connection of the power charging/discharging capacitor with the inductor has been turned on.

Each display electrode may include a scan electrode and a sustain electrode. The first and second discharge signals may be alternately applied to the scan electrode and the sustain electrode, or may be applied to only one of the scan electrode and the scan electrode.

The method may include determining ascent periods by controlling a turn-on timing of a second switch, configured to control connection of the scan electrode with a voltage source for supplying a sustain voltage, after a first switch, configured to control connection of a ground terminal in the power recovery circuit with the inductor has been turned on.

At least one of the above and other features and advantages of embodiments may be realized by providing an apparatus for driving a plasma display panel including a display driver configured to drive a plurality of display electrodes, an address driver configured to drive a plurality of address electrodes, and a controller configured to generate a display signal and an address signal, and further including an energy recovery circuit including a power charging/discharging capacitor, an inductor, and a plurality of switches, wherein the controller is configured to generate a first sustain discharge signal group adapted to continuously apply a first sustain discharge signal having a predetermined ascent period n times to the display electrodes, and a second sustain discharge signal group adapted to continuously apply a second sustain discharge signal having a longer ascent period than the predetermined ascent period for m times to the display electrodes.

The ascent period of the first sustain discharge signal may equal a time required for the voltage to increase to half of a maximum amplitude (Vs) of the first sustain discharge signal. A ratio of m second sustain discharge signals to n first sustain discharge signals may be about ⅓ or more.

The controller may be adapted to control ascent periods by controlling a time gap between turn-on of a second switch, configured to control connection of the display electrode with a voltage source for supplying a sustain voltage, after turn-on of a first switch, configured to control connection of the power charging/discharging capacitor with the inductor has been turned on.

The controller may be adapted to control ascent periods by controlling a turn-on timing of a second switch, configured to control connection of the scan electrode with a voltage source for supplying a sustain voltage, after a first switch, configured to control connection of a ground terminal in the power recovery circuit with the inductor has been turned on.

The display electrodes may include each of a scan electrode and a sustain electrode. The controller is adapted to apply the first and second discharge signals alternately to the scan electrode and the sustain electrode, or to only one of the scan electrode and the scan electrode.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic view of a plasma display panel that is driven in an AC-type 3-electrode surface emitting manner;

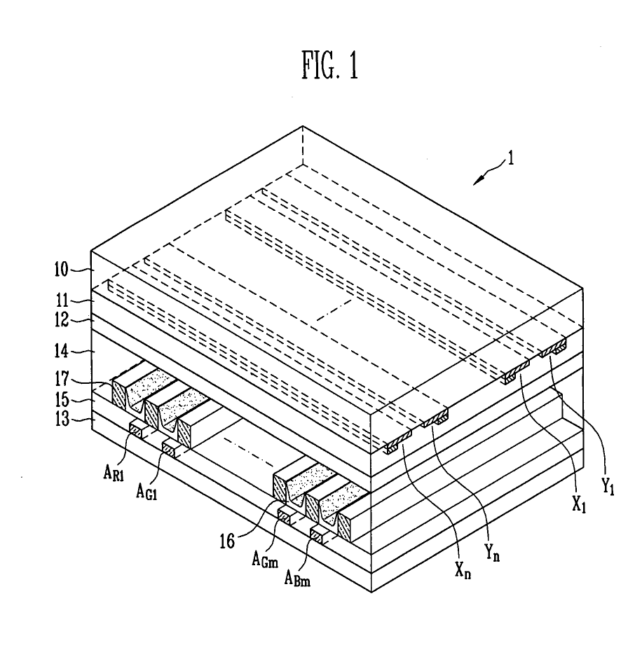

FIG. 2 illustrates a timing view showing a driving signal applied to a panel as shown in FIG. 1;

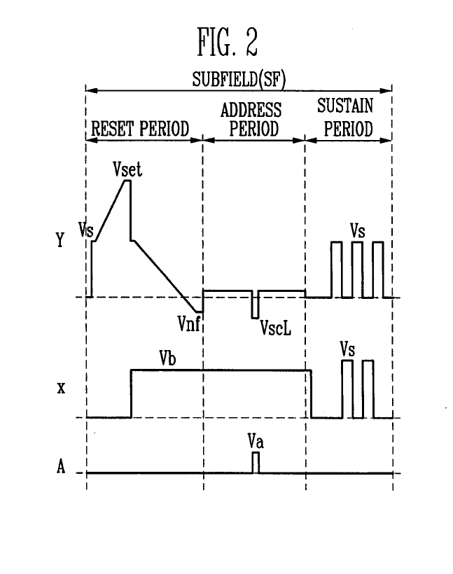

FIG. 3 illustrates a block diagram of an apparatus for driving a plasma display panel used with embodiments;

FIG. 4 illustrates a diagram of an energy recovery circuit used with embodiments;

FIGS. 5A and 5B illustrate diagrams of light output according to an ascending gradient of a sustain discharge signal in accordance with an embodiment;

FIG. 6 illustrates a driving waveform in which first and second sustain discharge signals are applied according to an embodiment;

FIG. 7 illustrates a graph of experimental data on an effect on reduction in a low discharge according to mixed ratios of the first sustain discharge signal and the second sustain discharge signal; and

FIG. 8 illustrates a driving waveform in which first and second sustain discharge signals are applied according to an embodiment.

### DETAILED DESCRIPTION OF THE INVENTION

Korean Patent Application No. 10-2006-0115153, filed on Nov. 21, 2006, in the Korean Intellectual Property Office, and entitled: “Apparatus and Method of Driving for Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

When one element is connected to another element, one element may be not only directly connected to another element but may also be indirectly connected to another element via another element. Further, irrelevant elements may be omitted for clarity. Like reference numerals refer to like elements throughout.

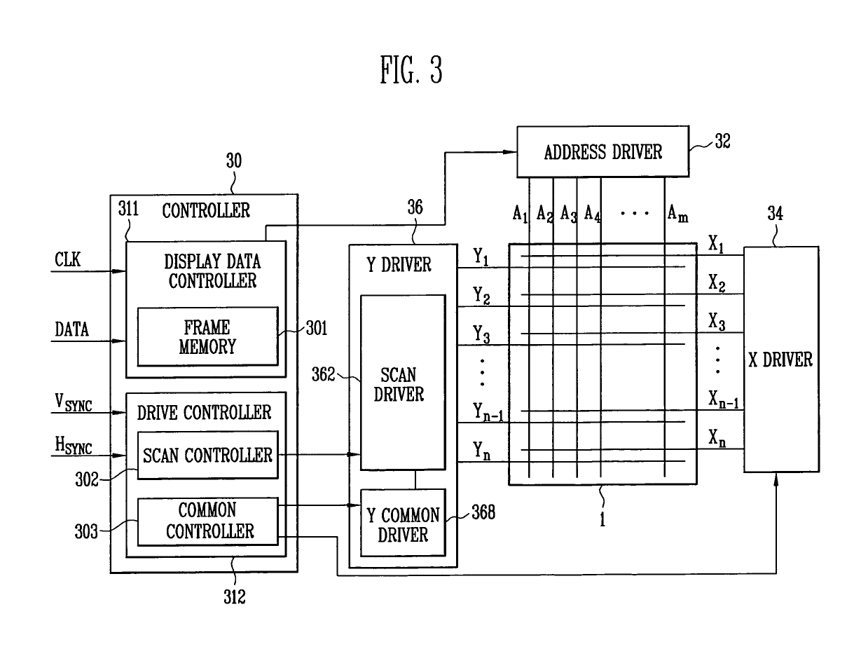

FIG. 3 illustrates a block diagram of an apparatus for driving the PDP 1 in accordance with embodiments.

Referring to FIG. 3, the driving apparatus may include a Y driver 36 for driving a plurality of the scan electrodes (Y1, . . . Yn); an X driver 34 for driving a plurality of the sustain electrodes (X1, . . . Xn); an address driver 32 for driving a plurality of the address electrodes (A1, . . . Am); and a controller 30 for generating a scan signal, a sustain discharge signal and an address signal, and for supplying the scan signal, the sustain discharge signal and the address signal to each of the drivers. The controller 30 may include a display data controller 311 and a drive controller 312. The Y driver 36 may include a scan driver 362 and a Y common driver 368.

The controller 30 may receive a clock signal (CLK), a data signal (DATA), a vertical synchronization signal (V_{SYNC}) and a horizontal synchronization signal (H_{SYNC}) externally. The display data controller 311 may store the data signal (DATA) in an internal frame memory 301 according to the clock signal (CLK), and may thereby supply a corresponding address control signal to the address driver 32.

The drive controller 312 for processing the vertical synchronization signal (V_{SYNC}) and the horizontal synchronization signal (H_{SYNC}) may include a scan controller 302 and a common controller 303. The scan controller 302 may generate signals for controlling the scan driver 362, and the common controller 303 may generate signals for controlling the Y common driver 368 and the X driver 34. The address driver 32 may process the address control signal from the display data controller 311 to apply the corresponding display data signals to address electrode lines (A1, . . . , Am) of the PDP 1 during the address period. The scan driver 362 of the Y driver 36 may apply the corresponding scan driving signal to scan electrode lines (Y1, . . . , Yn) according to the control signal from the scan controller 302 during the address period. The Y common driver 368 of the Y driver 36 may simultaneously apply the common driving signal to Y electrode lines (Y1, . . . , Yn) according to the control signal from the common controller 312 during the sustain discharge period. The X driver 34 may apply the common driving signal to X electrode lines (X1, . . . , Xn) according to the control signal from the common controller 303 during the sustain discharge period.

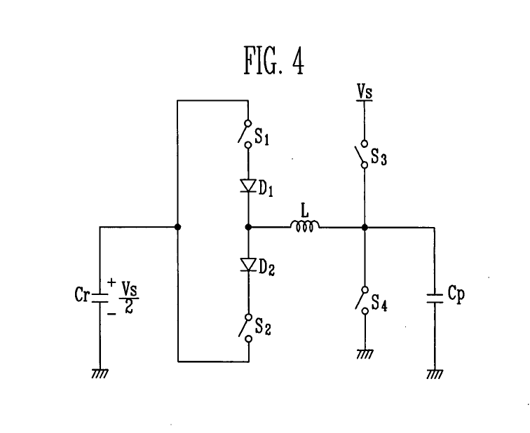

FIG. 4 illustrates a diagram of an energy recovery circuit (ERC) for applying a sustain discharge signal voltage (Vs) to a scan electrode or sustain electrode in a drive circuit of the PDP 1 through the Y driver 36 or the X driver 34. The ERC in FIG. 4 may be an ERC in which a reactive power is recovered and recycled, e.g., as proposed by L. F. Weber (U.S. Pat. Nos. 4,866,349 and 5,081,400, which are hereby incorporated by reference).

Referring to FIG. 4, the ERC may be connected to a panel capacitor (Cp) representing the capacitance of the PDP 1. The ERC may include voltage sources (Vs, GND) of sustain discharge signal; an inductor (L) for generating an LC resonance of the sustain discharge signal and forming a power transmitting path; a capacitor (Cr) for charging/discharging electrical power; diodes (D1, D2) for preventing an electrical current from flowing backwards; switches (S3, S4) for controlling connection of the panel capacitor (Cp) with the voltage sources; and switches (S1, S2) for controlling whether or not an energy of the capacitor (Cr) is charged (sunken) or supplied (sourced).

When the switch (S1) is turned on to apply the sustain discharge signal voltage (Vs) to the sustain electrode or scan electrode, resonance paths may be formed for the capacitor (Cr), the inductor (L) and the panel capacitor (Cp). Then a voltage of a first terminal corresponding to a sustain electrode or a scan electrode of the panel capacitor (Cp) may increase to the sustain discharge signal voltage (Vs).

When the first terminal of the panel capacitor (Cp) reaches the sustain discharge signal voltage (Vs), the switch (S3) may be turned on to clamp the voltage of the first terminal with the sustain discharge signal voltage (Vs) in the panel capacitor (Cp). The sustain discharge signal voltage (Vs) may be applied to the sustain electrode or scan electrode using the above method.

Meanwhile, when the switch (S2) is turned on to decrease a voltage applied to the panel capacitor (Cp), resonance paths may be formed for the capacitor (Cr), the inductor (L), and the panel capacitor (Cp). Then, the voltage charged in the panel capacitor (Cp) is charged in the capacitor (Cr). Then, the switch (S4) may be turned on to apply a GND voltage.

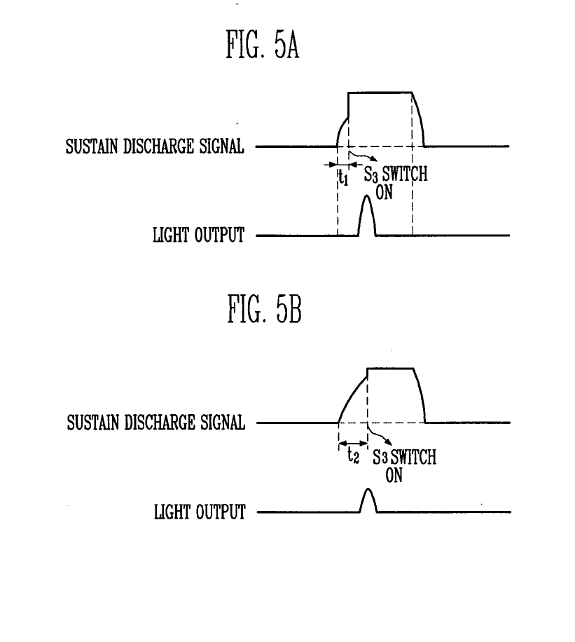

FIGS. 5A and 5B illustrate diagrams of light output according to an ascending gradient of a sustain discharge signal by adjusting a switching timing of the ERC in FIG. 4.

Referring to FIGS. 5A and 5B, the light output may be varied according to a delay in turning on the switch (S3) after the switch (S1) has been turned on, i.e., a resonance time or an ascent period.

That is to say, if the switch (S3) is turned on relatively quickly, e.g., after a short resonance time (t1), after the switch (S1) has been turned on, as shown in FIG. 5A, the sustain discharge signal may be suddenly clamped to the sustain discharge signal voltage (Vs) to emit the light having a relatively strong light output. But, if the switch (S3) is turned on relatively slowly, e.g., after a long resonance time (t2), after the switch (S1) has been turned on, as shown in FIG. 5B, then a light output is relatively weak, since the sustain discharge voltage (Vs) gradually increases due to the relatively longer resonance. The ascent gradients of the sustain discharge signals may be different from each other, as shown in FIGS. 5A and 5B. That is to say, a method for changing the ascent gradient of the sustain discharge signal may be achieved by adjusting resonance times of the sustain discharge signal, i.e., turn-on times of the switches (S1, S3), in an embodiment, as described above.

As shown in FIG. 5A, signal having a short resonance time, i.e., a signal having a relatively higher ascent gradient, may strongly maintain a sustain discharge to improve a light output, since a sustain voltage increases Vs over a relatively shorter period. However, a load of the switching elements may increase as a switching time decreases, increasing temperature of the PDP.

In contrast, as shown in FIG. 5B, a signal having a long resonance time, i.e., a signal having a relatively lower gradient of the sustain discharge signal, maintains a light output at a relatively lower level, i.e., is not as bright, since a sustain voltage increases to Vs more gradually, but an increase in temperature is reduced.

As described above, the sustain discharge signal having a short resonance time is referred to as a first sustain discharge signal, and the sustain discharge signal having a relatively longer resonance time than the first sustain discharge signal is referred to as a second sustain discharge signal. Thus, a low discharge due to high temperature may be reduced or eliminated by suitably mixing the first sustain discharge signal with the second sustain discharge signal.

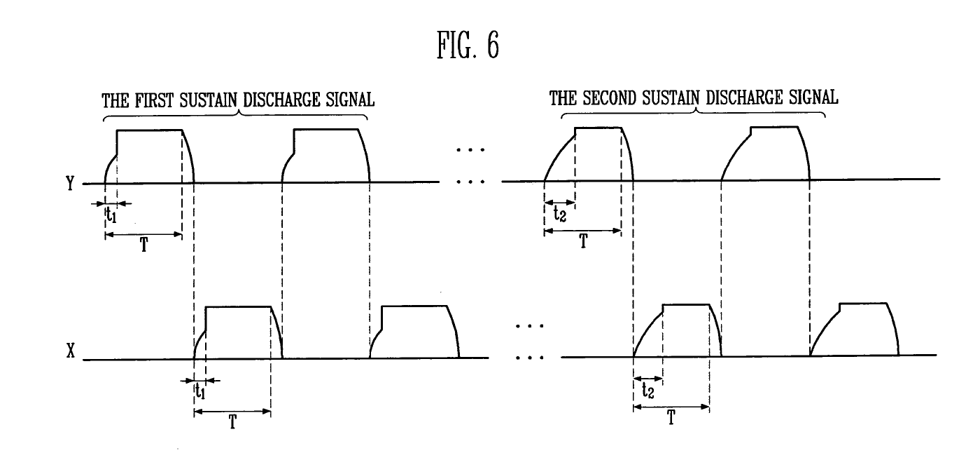

FIG. 6 illustrates a driving waveform in which the first and second sustain discharge signals are applied according to one embodiment of the present invention. Referring to FIG. 6, different groups of the sustain discharge signals may be applied alternately to the X/Y electrodes.

If the ascent period of the resonance of the first sustain discharge signal is set to t1 and the ascent period of the resonance of the second sustain discharge signal is set to t2, then t1 and t2 may satisfy the equation t1<t2. However, a time from an ascending time point to a descending time point is a constant period of “T”.

The ascent period of the first sustain discharge signal may equal the time it takes for the sustain discharge voltage to reach half of the maximum amplitude Vs, i.e., the switch (S3) may be turned on when the sustain discharge voltage equal ½ Vs.

Again, the control of the ascent period may be realized by controlling a turn-on timing of the second switch (S3), controlling connection of the X/Y electrodes with a voltage source (Vs) for supplying a sustain voltage, after the first switch (S1) is turned on, the first switch (S1) controlling connection of the inductor (L), which becomes a power transmitting path, with a power charging/discharging capacitor (Cr) in the ERC, as shown in FIG. 4.

The turn-on timing may be controlled by the drive controller 312 in the controller 30 as shown in FIG. 3, and the drive controller 312 may generate a control signal for the switch timing (ON timing of the S3 switch in FIG. 4) to transmit the generated control signal to X/Y drivers (34, 36) so as to adjust the ascent period of the sustain discharge signal.

A first sustain discharge signal may be continuously applied n times, and then a second sustain discharge signal may be continuously applied m times. This may provide a desired brightness by continuously applying the first sustain discharge signal, and then, the resultant increased temperature may be lowered by continuously applying the second sustain discharge signal, thereby reducing or eliminating the low discharge problem arising from the high temperature.

This may be realized by applying control signals for the switch timing to generate a first sustain discharge signal group and a second sustain discharge signal group, as described above, the first sustain discharge signal group continuously providing n number of the first sustain discharge signals through the drive controller 312 and the second sustain discharge signal group continuously providing m number of the second sustain discharge signals.

On the basis of the context as described above, a test of reduction in a low discharge was carried out by controlling a ratio of second sustain discharge signals to first sustain discharge signals.

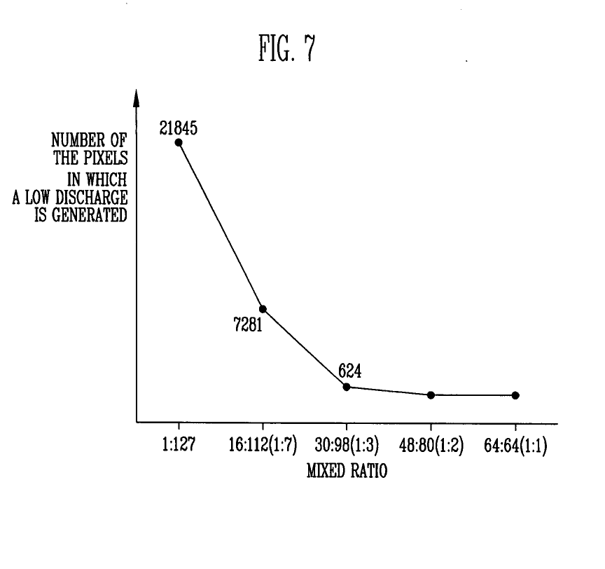

FIG. 7 illustrates a graph of experimental data on an effect on reduction in a low discharge according to ratios of second sustain discharge signals to first sustain discharge signals.

Referring to FIG. 7, an X-axis represents the ratio of second sustain discharge signals and first sustain discharge signals, and a Y-axis represents the number of the pixels in which a low discharge is generated.

Each pixel may include R, G, B cells as one unit, and a 42-inch panel used in this test has a total of 768 lines, each line having 1024 pixels. Therefore, the panel being tested has a total of 768*1024=786,432 pixels.

Referring to a relationship between the mixed ratio and pixels in which a low discharge is generated, if, for a total 128 pairs of the sustain discharge signals in one subfield, if only one pair of the second sustain discharge signals, i.e., m=1, and 127 pairs of the first sustain discharge signals, i.e., n=127, are applied, then the number of pixels in which a low discharge is generated is 21,845. If thirty pairs of the second sustain discharge signals, i.e., m=30, and ninety-eight pairs of the first sustain discharge signals are applied, i.e., n=98, then the number of pixels in which a low discharge is generated is 624. Accordingly, the reduction in the low discharge is significantly improved when the number of second discharge signals is increased relative to the number of first discharge signals.

As may be seen in FIG. 7, improvement in the number of pixels in which low discharge is generated improves dramatically until the ratio is about 1:3 or more. Accordingly, the ratio of the number m of second sustain discharge signals to the number n of first sustain discharge signals may be set to at least about ⅓. Also, the method for applying the sustain discharge signal to the Y electrode first is shown in FIG. 6, but the method for applying the sustain discharge signal to the X electrode first may also be used in accordance with an embodiment.

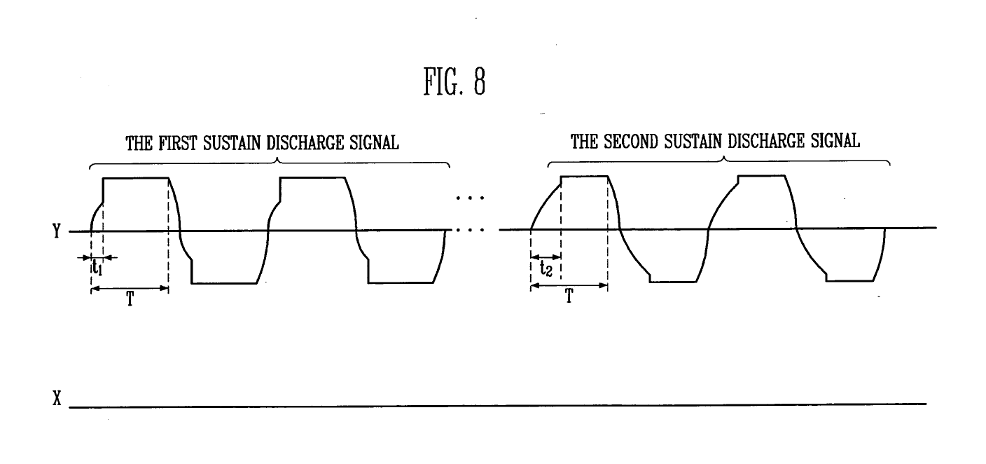

FIG. 8 illustrates a driving waveform in which the first and second sustain discharge signals are applied according to an embodiment.

Referring to FIG. 8, the same effect as in the embodiment of FIG. 6 may be realized by applying the first and second sustain discharge signal to either only the scan electrode or the sustain electrode. For this purpose, the controller 312 may apply the first and second sustain discharge signals to either the scan electrode or the sustain electrode.

As in the same manner as in FIG. 6, the first sustain discharge signal is continuously applied n times, and the second sustain discharge signal is continuously applied m times, wherein the first and second sustain discharge signals are applied to either the scan electrode or the sustain electrode.

Also, the mixed ratio of the first sustain discharge signal may be set to at least ⅓ of the entire sustain discharge signal applied into one subfield constituting a screen of the plasma display panel.

Meanwhile, in order to realize the embodiment of FIG. 8, a GND terminal may replace the energy charging capacitor (Cr) in the resonance circuit in FIG. 4, and a −Vs voltage source may replace the GND connected to the bottom of the switch (S4).

The low discharge at increased temperature may be lowered by partially changing a control signal without changing the established circuit configuration, as described above, the control signal being applied to the scan driver and/or the sustain driver through the drive controller 312 of the PDP.

As shown above in the graph of FIG. 7, the low discharge effect is more pronounced when at least ⅓ of the sustain discharge signals applied are the second sustain discharge signals. Further, low discharge caused by increased temperature may be lowered by mixing the first sustain discharge signal and the second sustain discharge signal.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display panel including a plurality of display electrodes and a plurality of address electrodes crossing the display electrodes, an energy recovery circuit including a power charging/discharging capacitor, an inductor, and a plurality of switches, the method comprising:
continuously applying a first sustain discharge signal having a predetermined ascent period for n times to the display electrodes; and
continuously applying a second sustain discharge signal having a longer ascent period than the predetermined ascent period for m times to the display electrodes.

2. The method for driving a plasma display panel as claimed in claim 1, wherein the predetermined ascent period of the first sustain discharge signal equals a time required for the voltage to increase to half of a maximum amplitude (Vs) of the first sustain discharge signal.

3. The method for driving a plasma display panel as claimed in claim 1, wherein a ratio of the m second sustain discharge signals to the n first sustain discharge signals is about ⅓ or more.

4. The method for driving a plasma display panel as claimed in claim 1, further comprising determining ascent periods by controlling a turn-on timing of a second switch, configured to control connection of the display electrode with a voltage source for supplying a sustain voltage, after a first switch, configured to control connection of the power charging/discharging capacitor with the inductor has been turned on.

5. The method for driving a plasma display panel as claimed in claim 1, wherein each display electrode includes a scan electrode and a sustain electrode,
the continuously applying the first discharge signal includes alternately applying the first sustain discharge signal to the sustain electrode and the scan electrode, and
the continuously applying the second discharge signal includes alternately applying the second sustain discharge signal to the sustain electrode and the scan electrode.

6. The method for driving a plasma display panel as claimed in claim 1, wherein each display electrode includes a scan electrode and a sustain electrode,
the continuously applying the first discharge signal includes applying the first sustain discharge signal to one of the sustain electrode and the scan electrode, and
the continuously applying the second discharge signal includes alternately applying the second sustain discharge signal to only one of the sustain electrode and the sustain electrode.

7. The method for driving a plasma display panel as claimed in claim 1, further comprising determining ascent periods by controlling a turn-on timing of a second switch, configured to control connection of the scan electrode with a voltage source for supplying a sustain voltage, after a first switch, configured to control connection of a ground terminal in the power recovery circuit with the inductor has been turned on.

8. An apparatus for driving a plasma display panel including a display driver configured to drive a plurality of display electrodes; an address driver configured to drive a plurality of address electrodes; and a controller configured to generate a display signal and an address signal, and further including an energy recovery circuit including a power charging/discharging capacitor, an inductor, and a plurality of switches, wherein the controller is configured to generate:
a first sustain discharge signal group adapted to continuously apply a first sustain discharge signal having a predetermined ascent period n times to the display electrodes; and
a second sustain discharge signal group adapted to continuously apply a second sustain discharge signal having a longer ascent period than the predetermined ascent period for m times to the display electrodes.

9. The apparatus for driving a plasma display panel as claimed in claim 8, wherein the ascent period of the first sustain discharge signal equals a time required for the voltage to increase to half of a maximum amplitude (Vs) of the first sustain discharge signal.

10. The apparatus for driving a plasma display panel as claimed in claim 8, wherein a ratio of m second sustain discharge signals to n first sustain discharge signals is about ⅓ or more.

11. The apparatus for driving a plasma display panel as claimed in claim 8, wherein the controller is adapted to control ascent periods by controlling a time gap between turn-on of a second switch, configured to control connection of the display electrode with a voltage source for supplying a sustain voltage, after turn-on of a first switch, configured to control connection of the power charging/discharging capacitor with the inductor has been turned on.

12. The apparatus for driving a plasma display panel as claimed in claim 8, wherein the controller is adapted to control ascent periods by controlling a turn-on timing of a second switch, configured to control connection of the scan electrode with a voltage source for supplying a sustain voltage, after a first switch, configured to control connection of a ground terminal in the power recovery circuit with the inductor has been turned on.

13. The apparatus for driving a plasma display panel as claimed in claim 8, wherein the display electrodes include each of a scan electrode and a sustain electrode.

14. The apparatus for driving a plasma display panel as claimed in claim 13, wherein the controller is adapted to apply the first and second sustain discharge signal groups to both the scan electrode and the sustain electrode.

15. The apparatus for driving a plasma display panel as claimed in claim 13, wherein the controller is adapted to apply the first and second sustain discharge signal groups to only the scan electrode or the sustain electrode.
